(19) United States
(12) Patent Application Publication
(10) Pub. No.: US 2018/0144098 A1
(43) Pub. Date: May 24, 2018

(54) DRUG COMBINATION PREDICTION SYSTEM AND DRUG COMBINATION PREDICTION METHOD

(71) Applicant: INSTITUTE FOR INFORMATION INDUSTRY, Taipei (TW)

(72) Inventors: Wei-I LIU, Kaohsiung City (TW); Yu-Shian CHIU, Taoyuan City (TW); Joey Jen-Hui SYU, Nantou County (TW); Chia-Shan HSIEH, Taipei City (TW); Mong-Hsun TSAI, New Taipei City (TW); Tzu-Pin LU, Taipei City (TW); Liang-Chuan LAI, Taipei City (TW); Eric Y. CHUANG, Taipei City (TW); Hui-I HSIAO, Yunlin County (TW)

(21) Appl. No.: 15/365,961

(22) Filed: Dec. 1, 2016

(30) Foreign Application Priority Data
Nov. 18, 2016 (TW) 105137928

(51) Int. Cl. G06F 19/00; G06F 19/12

(52) U.S. Cl. CPC G06F 19/326; G06F 19/12

(57) ABSTRACT

A drug combination prediction method comprising: storing a plurality of original gene sets, at least one first gene impacted by a first drug and at least one second gene impacted by a second drug; determining the part of the at least one first gene and the part of the at least one second gene to be a first interaction gene set; calculating a gene amount of the first interaction gene set to obtain a first interaction gene amount, and calculating a first percentage generated by the first interaction gene amount in the first original gene set; calculating an interaction value of the combination of the first drug and the second drug according to the first percentage; and selecting at least one synergistic pharmaceutical composition according to the interaction value.

### CROSS-REFERENCE TO RELATED APPLICATION

This application claims priority to Taiwan Application Serial Number 105137928, filed Nov. 18, 2016, which is herein incorporated by reference.

### BACKGROUND

### Field of Invention

The present invention relates to a drug combination prediction system and a drug combination prediction method. More particularly, the present invention relates to a drug combination prediction system and a drug combination prediction method related to drug synergistic effect.

### Description of Related Art

In general, it may cause the drug synergistic effect when combining different drugs. The drug synergistic effect means that when giving two or more drugs to the target organ or the target cell, the effect on the target organ or the target cell is equal to or more than the accumulated effect of each drug. The drug synergistic effect can be a treatment effect or untoward effect. Besides, the interaction effect is the basic information for confirming tumor or selecting the treatment. The health workers can add the dose of a specific drug according to the interaction effect to increase the effect. In addition, the health workers can decrease the dose of the specific drug according to the interaction effect to avoid toxic effects causing by using too much specific drug.

Therefore, the prediction of the drug combination effect is important when combining different drugs. By predicting the drug combination effect, the health workers can know whether the combined drug has the better effect. However, the calculation of the drug combination prediction is very complex. When there are too many different drugs, the combination methods of the drugs can be huge amount. It will need few days or few months to finish the calculation for analyzing the effect of all the combination drugs.

Therefore, how to effectively select the combination drugs to reduce the calculation amount of predicting the effect of combination drugs becomes a problem to be solved.

### SUMMARY

The invention provides a drug combination prediction system. The drug combination prediction system comprises a storage device and a processor. The storage device stores a database. Wherein, the database stores a plurality of original gene sets, at least one first gene impacted by a first drug and at least one second gene impacted by a second drug. Wherein, the original gene sets comprise a first original gene set, the first original gene set comprises a part of the at least one first gene and a part of the at least one second gene. And, the processor is coupled to the storage device and configure to determine the part of the at least one first gene and the part of the at least one second gene to be a first interaction gene set, calculate a gene amount of the first interaction gene set to obtain a first interaction gene amount, calculating an interaction value of the combination of the first drug and the second drug according to a first percentage generated by the first interaction gene amount of the first original gene set, and select at least one synergistic pharmaceutical composition according to the interaction value.

On another aspect, the invention provides a drug combination prediction method. The drug combination prediction method comprises: storing a plurality of original gene sets, at least one first gene impacted by a first drug and at least one second gene impacted by a second drug; wherein, the original gene sets comprise a first original gene set, the first original gene set comprises a part of the at least one first gene and a part of the at least one second gene; determining the part of the at least one first gene and the part of the at least one second gene to be a first interaction gene set; calculating a gene amount of the first interaction gene set to obtain a first interaction gene amount, and calculating a first percentage generated by the first interaction gene amount in the first original gene set; calculating an interaction value of the combination of the first drug and the second drug according to the first percentage; and selecting at least one synergistic pharmaceutical composition according to the interaction value.

Therefore, through the drug combination prediction system and the drug combination prediction method apply by calculating the interaction values of different drug combinations can predict the impact of the gene expression value causing by different drug combinations. Besides, the drug combination prediction system and the drug combination prediction method can select the drug combinations having a relatively higher interaction value and subsequently analyze the drug effects of these drug combinations. Thus, the invention substantially decreases the calculations of drug combination prediction.

### BRIEF DESCRIPTION OF THE DRAWINGS

The invention can be more fully understood by reading the following detailed description of the embodiment, with reference made to the accompanying drawings as follows:

FIG. 1 illustrates a flow chart of a drug combination prediction method according to an embodiment of the present invention;

FIG. 2 illustrates a block diagram of a drug combination prediction system according to an embodiment of the present invention;

FIGS. 3A-3B illustrate a schematic diagram of a drug combination prediction according to an embodiment of the present invention;

FIG. 4 illustrates a schematic diagram of a statistics calculation result according to an embodiment of the present invention;

FIG. 5 illustrates a flow chart of a drug combination prediction method according to an embodiment of the present invention;

FIG. 6 illustrates a flow chart of a selection mechanism according to an embodiment of the present invention;

FIG. 7 illustrates a schematic diagram of a drug combination analysis according to an embodiment of the present invention; and

FIGS. 8A-8B illustrates schematic diagrams of selecting drug combination according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

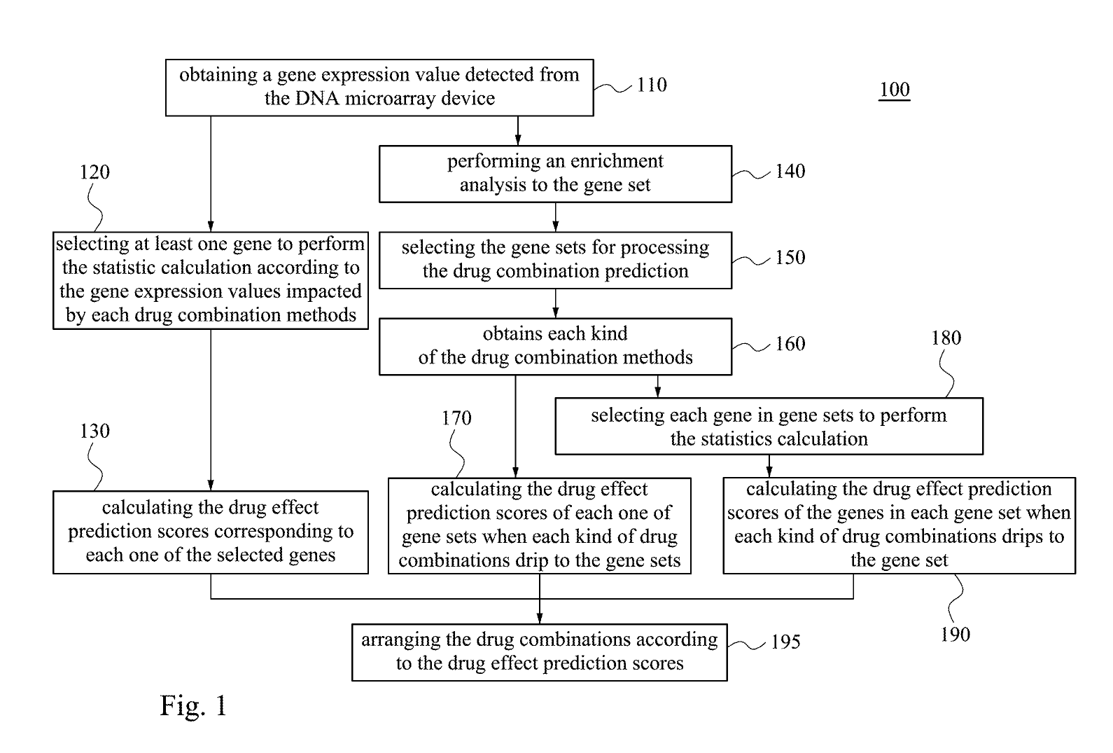

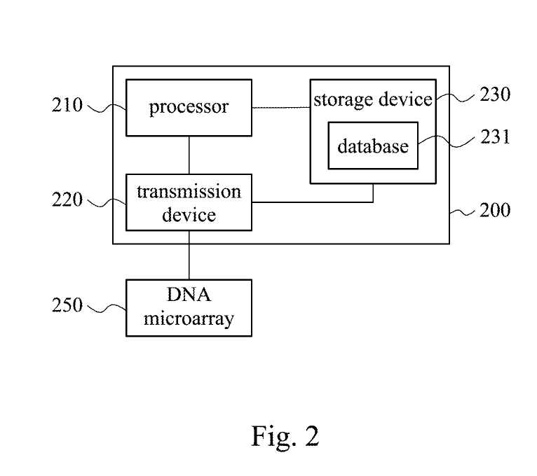

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments. Reference is made to FIGS. 1-2. FIG. 1 illustrates a flow chart of a drug combination prediction method 100 according to an embodiment of the present invention. FIG. 2 illustrates a block diagram of a drug combination prediction system 200 according to an embodiment of the present invention. In one embodiment, the drug combination prediction system 200 includes a processor 210 and a storage device 230. The processor 210 is coupled to the storage device 230.

In one embodiment, the storage device 230 includes a database 231.

In one embodiment, the processor 210 uses for executing multiple kinds of calculations, and the processor 210 can be implemented by such as a microcontroller, a microprocessor, a digital signal processor, an application specific integrated circuit (ASIC), or a logic circuit.

In one embodiment, the storage device 230 can be implemented by using a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

In one embodiment, the drug combination prediction system 200 further comprises a transmission device 220 and a DNA microarray 250. In one embodiment, the transmission device 220 can be implemented by a router chip, a digital processing component and/or a network card. In one embodiment, the transmission device receives a gene expression value from a DNA microarray device 250. And, the gene expression value is detected by the DNA microarray device 250.

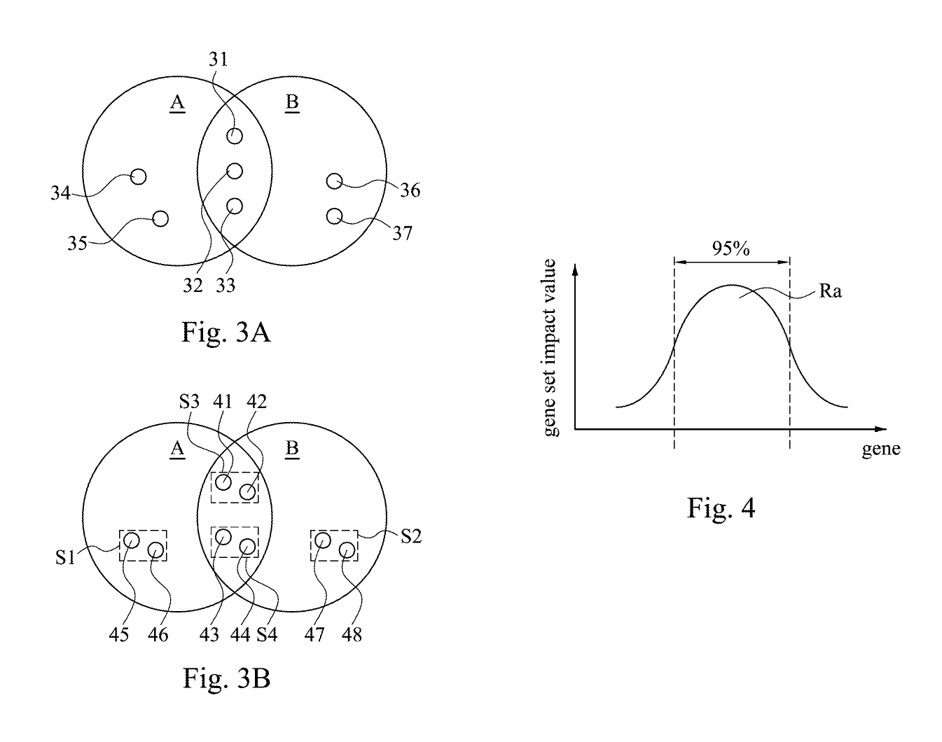

Next, references are made to FIGS. 1 and 3A-3B. FIGS. 3A-3B illustrates a schematic diagram of a drug combination prediction according to an embodiment of the present invention.

In step 110, the processor 210 obtains a gene expression value detected from the DNA microarray device 250 by the transmission device 220.

In one embodiment, when the drug drips to the DAN microarray device 250 for treatment the cell, the drug may make gene change the gene expression value (e.g. a drug make a gene produce more enzyme). Therefore, the treatment effect can be inducted according to the gene expression value.

After the step 110, the step 120 and/or the step 140 can be performed in the same time or one after another.

In step 120, the processor 210 selects at least one gene to perform the statistic calculation according to the gene expression values impacted by each drug combination method.

As shown in FIG. 3A, the drug A can impact the gene expression value of genes 31-35. The drug B can impact the gene expression value of genes 31-33 and 36-37. When the drug A and the drug B are combined, both the drug A and drug B can impact the gene expression value of genes 31-33. Therefore, the processor 210 selects genes to perform the statistic calculation.

In step 130, when each kind of drug combinations drips to the selected genes, the processor 210 respectively calculates the drug effect prediction scores corresponding to each one of the selected genes. As shown in FIG. 3A, the processor 210 calculates the drug effect prediction scores of each one of the selected genes 31-33.

In one embodiment, the processor 210 calculates the drug effect prediction scores according to a first algorithm, which is an existing algorithm (e.g. Co-gene score calculation) to calculate the drug effect prediction scores of the genes 31-33. Because the first algorithm can be implemented by the known algorithms, no further description herein.

In step 140, the processor 210 performs an enrichment analysis to the gene set.

In one embodiment, the processor 210 classifies the genes having similar functions into a same gene set. In one embodiment, the database 231 uses for storing these gene sets.

In one embodiment, the enrichment analysis means that after the drug drips to the DNA microarray device 250, the DNA microarray device 250 detects the value according to the impact of the gene causing by the drug. The processor 210 performs the statistics calculation to calculate the value, and then each gene set can correspond to a gene set impact value. The gene set impact value is used for representing the drug impact of each gene set. Wherein, the static calculation can be standard deviation calculation, normalization calculation and/or normal distribution calculation.

In one embodiment, the genes of each gene set also can be performed the statistics calculation to respectively correspond to the gene impact values. The gene impact values respectively represent the drug impact of each one of the genes.

In step 150, the processor 210 obtains a p-value from the database 231. And, the processor 210 selects the gene sets for processing the drug combination prediction according to the p-value. Wherein, the p-value can be understood as a threshold defining according to the statistics. For example, when the processor 210 configures the p-value as 5%, the processor 210 selects the 5% gene sets from the gene set samples (e.g. the total number of the gene set samples is 1000, the processor 210 selects 50 gene sets from the gene set samples) for processing the drug combination prediction.

In one embodiment, as shown in FIG. 4, FIG. 4 illustrates a schematic diagram of a statistics calculation result according to an embodiment of the present invention. When the to-be tested drug (e.g. the combination of drug A and drug B) drips to each kind of gene sets, the processor 210 can calculate the impact levels of each kind of gene sets, so as to obtain the multiple gene set impact values. Herein, the impact levels correspond to the to-be tested drug.

For instance, the statistics calculation result of impact value of the gene set can be a normal distribution type. The gene set impact values represent that whether the drug impacts each kind of gene sets (or the genes in the gene sets). In the statistics calculation result, the confidence interval Ra occupies 95% (it means that these genes are not impacted by the drug too much). And, the other intervals (which is out of the confidence interval Ra) occupies 5% (it means the behaviors of these genes are different from other genes, and these genes are more impacted by the drug).

Therefore, the processor 210 selects the gene sets located in the intervals out of confidence interval Ra, to processing the bellowing calculations.

In step 160, the processor 210 obtains each kind of the drug combination methods from database 231. For example, database 231 records that the drug A and the drug B can be combined, the drug A and the drug C can be combined.

In one embodiment, after the processor 210 performs the step 160, the step 170 and the step 180 can be performed in the same time or one after another.

In step 170, the processor 210 calculates the drug effect prediction scores of each one of gene sets when each kind of drug combinations drip to the gene sets. For example, in FIG. 3B, the processor 210 can obtain the information that the drug A impacts the gene sets S1, S3, S4, and the drug B impacts the gene sets S2, S3, S4, according to the records of database 231. Wherein, the gene sets S3, S4 can be impacted by the drug A and the drug B in the same time. Therefore, the combination of the drug A and the drug B may cause the drug synergistic effect. As such, the processor 210 calculates the drug effect prediction scores of the combination of the drug A and the drug B acting on the gene sets S3 and S4, respectively.

In one embodiment, the processor 210 calculates the drug effect prediction scores according to a second algorithm, which is an existing algorithm (e.g. Co-GS score calculation) to calculate the drug effect prediction scores of the gene sets S3 and S4. Because the second algorithm can be implemented by the known algorithms, no further description herein.

In step 180, the processor 210 selects each gene in gene sets to perform the statistics calculation. In one embodiment, as shown in FIG. 3B, the processor 210 selects genes 41-44 in gene sets S3 and S4 to perform the statistics calculation.

In step 190, the processor 210 calculates the drug effect prediction scores of the genes in each gene set when each kind of drug combinations drips to the gene set. For example, in FIG. 3B, the processor 210 calculates the drug effect prediction scores according to a third algorithm, which is an existing algorithm (e.g. Co-gene/CS score calculation) to calculate the drug effect prediction scores of each gene in the gene sets S3 and S4. Because the third algorithm can be implemented by the known algorithms, no further description herein.

In step 195, the processor 210 arranges the drug combinations according to the drug effect prediction scores calculated by the first algorithm, the second algorithm and the third algorithm, so as to predict the effect rank of each kind of drug combinations.

However, the data amount of the above steps 110-190 is too large. The processor 210 needs more time to perform calculation. Therefore, the invention further selects at least one synergistic pharmaceutical composition according to the interaction information of the drug combination. In this way, the steps 120-195 only need to consider the gene sets or the genes of the at least one synergistic pharmaceutical composition to reduce the calculation amount of the steps 120-195.

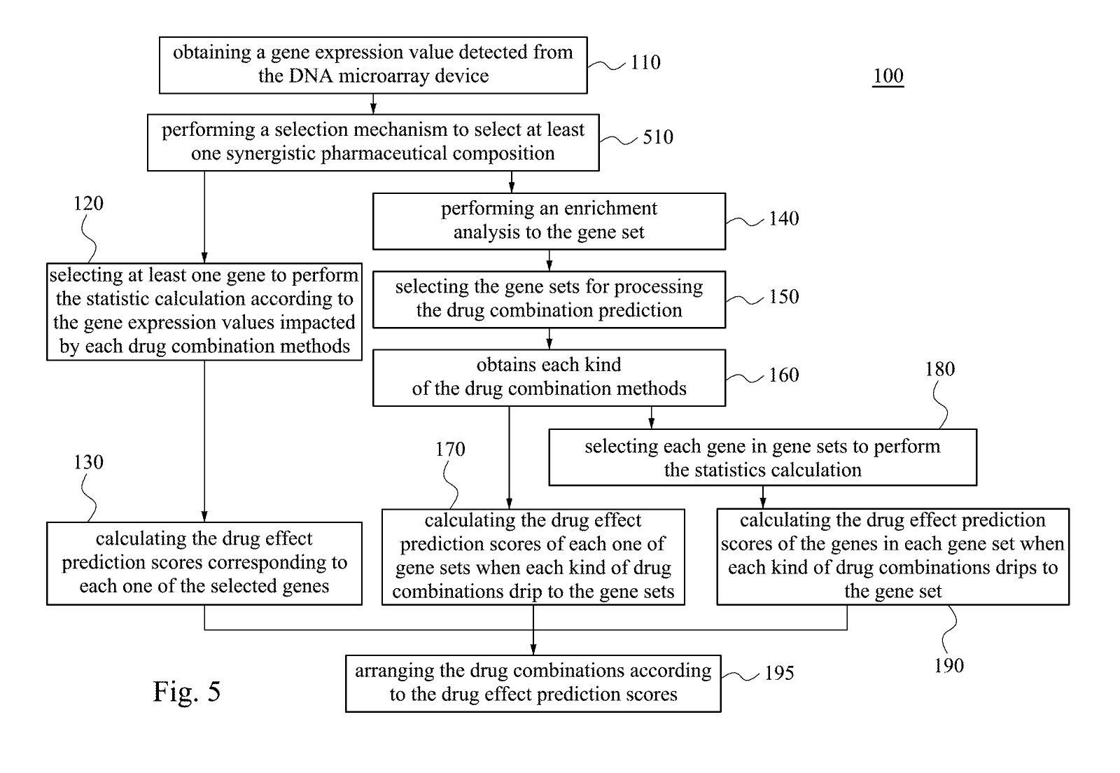

Reference is made to FIG. 5. FIG. 5 illustrates a flow chart of a drug combination prediction method 500 according to an embodiment of the present invention. The difference between FIG. 5 and FIG. 1 is that FIG. 5 further comprises the step 510.

In step 510, the processor 210 performs a selection mechanism to select at least one synergistic pharmaceutical composition.

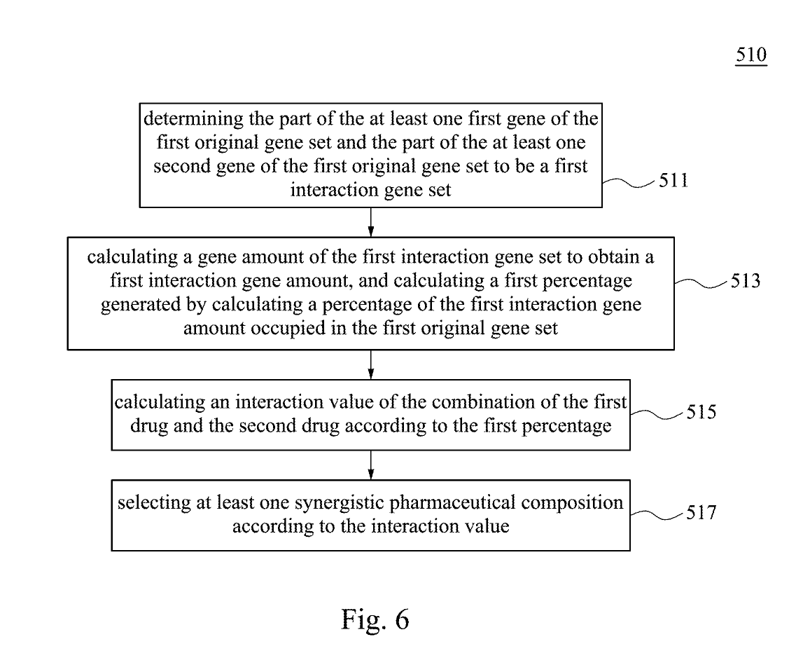

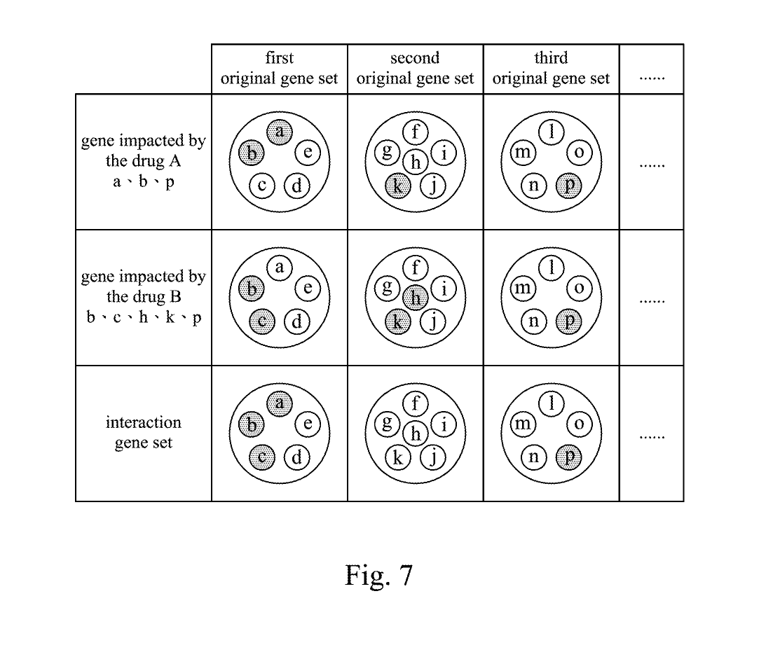

Next, reference is made to FIGS. 2 and 6-7. FIG. 6 illustrates a flow chart of a selection mechanism 510 according to an embodiment of the present invention. FIG. 7 illustrates a schematic diagram of a drug combination analysis according to an embodiment of the present invention.

In one embodiment, the processor 210 analyzes the gene expression value to obtain at least one first gene (e.g. gene a, b, p) impacted by a first drug and obtain at least one second gene (e.g. gene b, c, h, k, p) impacted by a second drug.

In one embodiment, the storage device 230 stores a database 231. The database 231 stores multiple original gene sets. As shown in FIG. 7, the original gene sets includes a first original gene set, a second original gene set and/or a third original gene set. Besides, the database 231 stores at least one first gene impacted by the drug A and at least one second gene impacted by the drug B. Wherein, the first original gene set comprises a part of the at least one first gene and a part of the at least one second gene.

In step 511, please refer to the column of the first original gene set in FIG. 7. Taken this column for example, when the processor 210 obtains the information according to the database 231 that the drug A impacts genes a, b, p (these genes are called as the first gene) and the drug B impacts genes b, c, h, k, p (these genes are called as the second gene), the processor 210 determines the part of the at least one first gene (e.g. genes a, b, in this example) of the first original gene set (which comprises genes a, b, c, d, e) and the part of the at least one second gene (e.g. genes b, c, in this example) of the first original gene set (which comprises genes a, b, c, d, e) to be a first interaction gene set (which comprises genes a, b and c).

Besides, in the second original gene set, when the second original gene set comprises the part of the at least one second gene (e.g. genes h, k) and does not comprise the part of the at least one first gene, the processor 210 determines that the combination of the drug A and the drug B does not make the second original gene set cause the interaction effect. As such, the second original gene set does not correspond to any interaction gene set.

In the third original gene set, when the processor 210 obtains the information according to the database 231 that the drug A impacts gene p and the drug B also impacts gene p, the processor 210 determines the part of the at least one first gene (e.g. gene p, in this example) of the third original gene set (which comprises genes l, m, n, o, p) and the part of the at least one second gene (e.g. gene p, in this example) of the third original gene set (which comprises genes l, m, n, o, p) to be a second interaction gene set (which comprises gene p).

In one embodiment, the processor 210 combines the first interaction gene set (which comprises genes a, b, c) and second interaction gene set (which comprises gene p) to form an union interaction gene set (which comprises genes a, b, c, p).

Because some of drug combinations may have the characteristic of drug conduction, and drug conduction may cause the effects to the genes. Therefore, when the drug A and the drug B both impact the partial gene of the same gene set (e.g. the first original gene set, the third original gene set), the processor 210 determines the partial gene to be the interaction gene set. It means that the combination of the drug A and the drug B may cause the interaction effect to the partial gene(s).

In step 513, the processor 210 calculates a gene amount of the first interaction gene set (which comprises genes a, b, c) to obtain a first interaction gene amount (that is, 3). And then, the processor 210 calculates a first percentage (that is, ⅗=0.6) generated by calculating a percentage of the first interaction gene amount (that is, 3) occupied in the first original gene set (the first original gene set comprises genes a, b, c, d, e, the gene amount of the first original gene set is 5).

In the third original gene set, the processor 210 calculates a gene amount of the second interaction gene set (which comprises gene p) to obtain a second interaction gene amount (that is, 1). And then, the processor 210 calculates a second percentage (that is, ⅕=0.2) generated by calculating a percentage of the second interaction gene amount (that is, 1) occupied in the third original gene set (the third original gene set comprises genes l, m, n, o, p, the gene amount of the third original gene set is 5).

Due to the combination of the drug A and the drug B does not make the second original gene set occur the interaction effect(s). As such, the processor 210 does not perform the calculation according to the second original gene set. And, the processor 210 directly sets a percentage corresponding to the second original gene set to be zero.

In step 515, the processor 210 calculates an interaction value of the combination of the first drug (e.g. drug A) and the second drug (e.g. drug B) according to the first percentage (0.6). It should be noticed that when the processor 210 calculates multiple percentages (e.g. the first percentage and the second percentage), the processor 210 will accumulate all the percentages to obtain a result. And, the processor 210 divides the result by the set number of the original gene sets.

In one embodiment, the processor 210 calculates the interaction value of the combination of the drug A and the drug B according to the first percentage (0.6) and the second percentage (0.2). For instance, the processor accumulates the first percentage (0.6) and the second percentage (0.2) to obtain an impact parameter (0.8), and the processor 210 divides the impact parameter by a set number of the original gene sets (e.g. the original gene sets is 20), so as to obtain the interaction value (0.8/20=0.04) corresponding to the combination of the drug A and the drug B.

In another aspect, when the second original gene set comprises the part of the at least one second gene (e.g. comprising genes h, k) and does not comprise any part of the at least one first gene, the processor 210 determines that the interaction value corresponding to the combination of the drug A and the drug B is zero.

In step 517, the processor 210 selects at least one synergistic pharmaceutical composition according to the interaction value.

In one embodiment, the processor 210 further determines that whether the interaction value is zero. If the interaction value is zero, the processor 210 excludes the combination of the drug A and the drug B.

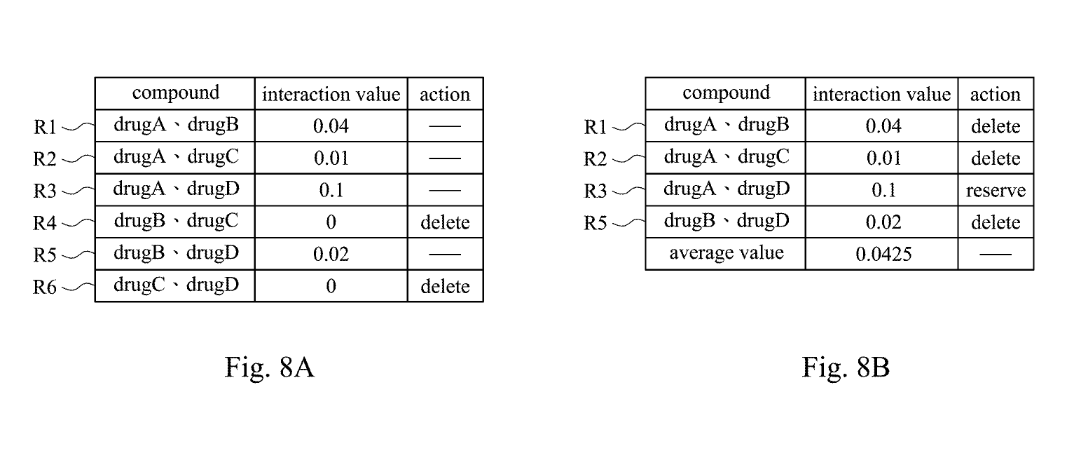

Reference is made to FIGS. 8A-8B. FIGS. 8A-8B illustrates schematic diagrams of selecting drug combination according to an embodiment of the present invention. In FIG. 8A, the processor 210 can calculate the interaction values of different compounds of drug combinations according to the above steps. For example, the interaction values of the drug A and the drug B, the interaction values of the drug A and the drug C, the interaction values of the drug B and the drug C, etc. Next, the processor 210 determines the interaction values are zero in raw R4, R6. Therefore, the processor 210 deletes the data in raw R4, R6 and only reserves the data in raw R1-R3 and R5 (as shown in action column of FIG. 8B).

In one embodiment, the processor 210 can apply the above steps to calculate another interaction value of the drug A and the drug C (e.g. 0.01) and calculate an average value of the interaction value (the interaction value of the drug A and the drug B is 0.04) and another interaction value (another interaction value of the drug A and the drug C is 0.01).

When the interaction value is higher than the average value, the processor 210 determines the combination of the drug A and the drug B to be one of the at least one synergistic pharmaceutical composition.

In one embodiment, as shown in 8B, the processor 210 calculates the average value of the interaction value in raw R1-R3 and R5 is 0.0425. And, the processor 210 reserves the data which is higher than or equal to the average value (e.g. the data of raw R3). The processor 210 deletes the data which is lower than the average value (e.g. the data of raw R1, R2 and R5). In this moment, the processor 210 determines the combination of the drug A and the drug D recited in raw R3 to be one of the at least one synergistic pharmaceutical composition.

The interaction value can represent the interactive level of the combination of two drugs, and the processor 210 can delete the data which is lower than the average value and then only reserve the drug combination(s) having the higher interaction effect for the subsequent drug effect analysis (e.g. performing the steps 120-195). As such, the drug combination prediction method and drug combination prediction system substantially decrease the calculations of subsequent drug combination prediction.

In one embodiment, the processor 210 further predicts a rank of a drug effect according to the at least one synergistic pharmaceutical composition. For example, the interaction value of the first synergistic pharmaceutical composition is 0.1. The interaction value of the second synergistic pharmaceutical composition is 0.2. Thus, the rank of the second synergistic pharmaceutical composition is higher than the first synergistic pharmaceutical composition.

As such, the processor 210 can find the synergistic pharmaceutical compositions with the higher ranks. Wherein, the synergistic pharmaceutical composition with the higher rank represents that it have the better drug effect according to the prediction.

Therefore, through the drug combination prediction system and the drug combination prediction method apply the interaction values of different drug combinations to predict the impact of the gene expression value causing by different drug combinations. Besides, the drug combination prediction system and the drug combination prediction method can select the drug combinations have a relatively high interaction value and subsequently analyze the drug effects of these drug combinations. Thus, the invention substantially decreases the calculations of drug combination prediction.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A drug combination prediction system, comprising:
a storage device, for storing a database, the database stores a plurality of original gene sets, at least one first gene impacted by a first drug and at least one second gene impacted by a second drug, the original gene sets comprise a first original gene set, the first original gene set comprises a part of the at least one first gene and a part of the at least one second gene; and
a processor, coupled to the storage device and configured to determine the part of the at least one first gene and the part of the at least one second gene to be a first interaction gene set, calculate a gene amount of the first interaction gene set to obtain a first interaction gene amount, calculate an interaction value of the combination of the first drug and the second drug according to a first percentage generated by the first interaction gene amount of the first original gene set, and select at least one synergistic pharmaceutical composition according to the interaction value.

2. The drug combination prediction system of claim 1, further comprising:
a transmission device, for receiving a gene expression value from a DNA microarray device; and
the processor analyzes the gene expression value to know the at least one first gene impacted by the first drug and the at least one second gene impacted by the second drug.

3. The drug combination prediction system of claim 1, wherein the original gene sets comprise a second original gene set;
wherein, when the second original gene set comprises the part of the at least one second gene and does not comprise the part of the at least one first gene, the processor determines that the interaction value corresponding to the combination of the first drug and the second drug is zero.

4. The drug combination prediction system of claim 1, wherein the original gene sets comprise a third original gene set; and
the third original gene set comprises the part of the at least one first gene and the part of the at least one second gene, the processor further determines the part of the at least one first gene of the third original gene set and the part of the at least one second gene of the third original gene set to be a second interaction gene set, obtains a second interaction gene amount according to the second interaction gene set, calculate a second percentage generated by the second interaction gene amount in the third original gene set, and calculate the interaction value of the combination of the first drug and the second drug according to the first percentage and the second percentage.

5. The drug combination prediction system of claim 4, wherein the processor accumulates the first percentage and the second percentage to obtain an impact parameter, and the processor divide the impact parameter by a set number of the original gene sets, so as to obtain the interaction value corresponding to the combination of the first drug and the second drug.

6. The drug combination prediction system of claim 5, wherein the processor excludes the combination of the first drug and the second drug if the interaction value is zero.

7. The drug combination prediction system of claim 5, wherein the processor further calculates another interaction value corresponding to the combination of the first drug and a third drug, and calculates an average value of the interaction value and the another interaction value; and
when the interaction value is higher than the average value, the processor determines the combination of the first drug and the second drug to be one of the at least one synergistic pharmaceutical composition.

8. The drug combination prediction system of claim 1, wherein the processor further predicts a rank of a drug effect according to the at least one synergistic pharmaceutical composition.

9. A drug combination prediction method, comprising:
storing a plurality of original gene sets, at least one first gene impacted by a first drug and at least one second gene impacted by a second drug, the original gene sets comprise a first original gene set, the first original gene set comprises a part of the at least one first gene and a part of the at least one second gene;
determining the part of the at least one first gene and the part of the at least one second gene to be a first interaction gene set;
calculating a gene amount of the first interaction gene set to obtain a first interaction gene amount, and calculating a first percentage generated by the first interaction gene amount in the first original gene set;
calculating an interaction value of the combination of the first drug and the second drug according to the first percentage; and
selecting at least one synergistic pharmaceutical composition according to the interaction value.

10. The drug combination prediction method of claim 9, further comprising:
receiving a gene expression value from a DNA microarray device; and
analyzing the gene expression value to know the at least one first gene impacted by the first drug and the at least one second gene impacted by the second drug.

11. The drug combination prediction method of claim 9, wherein the original gene sets comprise a second original gene set, and the drug combination prediction method further comprising:
when the second original gene set comprises the part of the at least one second gene and does not comprise the part of the at least one first gene, determining that the interaction value corresponding to the combination of the first drug and the second drug is zero.

12. The drug combination prediction method of claim 9, wherein the original gene sets comprise a third original gene set, the third original gene set comprises the part of the at least one first gene and the part of the at least one second gene, and the drug combination prediction method further comprising:
determining the part of the at least one first gene of the third original gene set and the part of the at least one second gene of the third original gene set to be a second interaction gene set;
obtaining a second interaction gene amount according to the second interaction gene set, and calculating a second percentage generated by the second interaction gene amount in the third original gene set; and
calculating the interaction value of the combination of the first drug and the second drug according to the first percentage and the second percentage.

13. The drug combination prediction method of claim 12, further comprising:
accumulating the first percentage and the second percentage to obtain an impact parameter; and
dividing the impact parameter by a set number of the original gene sets, so as to obtain the interaction value corresponding to the combination of the first drug and the second drug.

14. The drug combination prediction method of claim 13, the step of selecting the at least one synergistic pharmaceutical composition according to the interaction value further comprising:
determining whether the interaction value is zero; and
excluding the combination of the first drug and the second drug if the interaction value is zero.

15. The drug combination prediction method of claim 13, further comprising:
calculating another interaction value corresponding to the combination of the first drug and a third drug;
calculating an average value of the interaction value and the another interaction value; and
determining the combination of the first drug and the second drug to be one of the at least one synergistic pharmaceutical composition when the interaction value is higher than the average value.

16. The drug combination prediction method of claim 9, further comprising:
predicting a rank of a drug effect according to the at least one synergistic pharmaceutical composition.
